(19) United States
(12) Patent Application Publication
(10) Pub. No.: US 2008/0111376 A1
(43) Pub. Date: May 15, 2008

(54) Manifold for Fluids

(75) Inventor: Riccardo Ferrero, Cuneo (IT)

Correspondence Address: SUGHRUE MION, PLLC, 2100 PENNSYLVANIA AVENUE, N.W., SUITE 800, WASHINGTON, DC, 20037, US

(73) Assignee: FERRERO RUBINETTERIE S.R.L., FARIGLIANO (CUNEO) (IT)

(21) Appl. No.: 11/908,926

(22) PCT Filed: Mar. 14, 2006
(86) PCT No.: PCT/IB06/50787

§ 371 Date: Sep. 17, 2007

(30) Foreign Application Priority Data
Mar. 15, 2005 (IT) TO2005U000035

(51) Int. Cl. F16L 17/00

(52) U.S. Cl. 285/376

(57) ABSTRACT

The present invention relates to a manifold for fluids (10) comprising quick action elements, male- (15) or female (16), wherein one of such elements, in particular the female element (16), comprises an annular protecting shell (33) arranged so as to protect the coupling male element from tampering or damages after the coupling is assembled Since the manifold (10) has a simple structure, can be made either of plastic- or of metallic material.

### FIELD OF THE ART

The present invention relates to a manifold for fluids comprising at least a quick action coupling suitable for being connected to other manifolds, pipe fittings, pipings and hydraulic devices in general for supplying fluids.

In particular, the present invention relates to manifolds comprising interlocking quick couplings suitable for allowing various fluids to be supplied such as water, oil, compressed air or the like, in houses or industrial structures.

In the present description the term manifold is used as referring to devices for supplying fluids comprising a main inlet and a main outlet (inlet gate and outlet gate), of course reversible one with the other, and one or more side outlets (offtakes), generally having smaller dimensions, for allowing either the flow the fluid or controlling parameters of the fluid (temperature, capacity, etc).

Such kinds of manifolds are generally used for supplying fluids in residential environments.

As an example, in the case of building heating systems, such manifolds are used for receiving a warm water piping at their main inlet coming from the boiler and for supplying the water to a plurality of heating bodies (radiating panels or heaters, pipes, etc) through the offtakes of the building.

Normally the manifolds are connected one to another at their outlet so as to allow water to be supplied at a plurality of offtakes.

Such manifolds can also be used, as an example, for supplying sanitary water or compressed air and/or various fluids.

### BACKGROUND ART

Quick action couplings and manifolds provided with quick action couplings are known in the art.

For instance, an example of manifold is known from the patent document published with the number WO01/71236 provided with a quick action coupling of interlocking kind in which a male element (male) and a corresponding female element (female) are provided, at the main inlet and at the main outlet (outlet), suitable for being connected or coupled by interlocking with other manifolds or hydraulic devices, by means of a quick coupling.

The male and the female are provided with respective protrusions or projections consisting of two annular segments suitable for being coupled with interlocking by inserting the male in the female and by rotating thereafter one of the elements relative to the other by approximately 90°.

According to the background art, the protrusions are at sight (visible) in order to allowing an operator to easily recognise the correct mutual connection easy, as an example, of many manifolds.

A problem of the cited background art is that the protrusions, protruding from the outline of the coupling, can be hit and damaged before and during the assembly.

Moreover, after assembly the protrusions, in particular the protrusion of the female, always since they protrude from the outline of the coupling, as an example can be broken or damaged due to accidental hits and also be uncoupled of disconnected from the coupling.

An example of spraying head with associated a quick action coupling is also known from the patent document published with the number WO 97/33698.

The coupling, particularly complex, comprises a male and a female suitable for being coupled each with the other by interlocking.

In this case, the male and the female—the latter being protected by a guard—comprise respective helic-shaped fins. By rotating one of the fins relative to the other two gaskets—an inner one and an outer one, both provided on the coupling—are compressed, and a liquid-tight connection is obtained by compressing the gaskets in an axial direction relative to the coupling.

The rotation of one of the fins relative to the other is controlled with a mechanical stop arranged inside the fin of the female.

A first problem of this kind of couplings is that the relative rotation of the male relative to the female is controlled by means of the mechanical stop in the female, the female being protected by the guard, and therefore the possible dirt on the mechanical stop can prevent the coupling from being completely closed.

A further problem of this kind of couplings is that it is particularly complex and therefore can be made—as set forth in the document—only of plastic material by molding. In fact this kind of coupling has such complex structural features that manufacturing it made of metal would not be worth to be considered.

Summing up, the Applicant observes that known quick couplings
in a first case are provided with protrusions that make them not reliable enough or subject to damages; and
in a second case, when the protrusions are protected with a guard, are provided with not visible mechanical stops that not allow checking the complete closing of the coupling.

### SUMMARY OF THE INVENTION

An object of the present invention is solving the problems of the background art previously set forth.

According to the present invention, this object is achieved by means of a manifold for fluids having the features according to the following claims.

The claims are part of the technical teachings provided hereby concerning the invention. According to a preferred embodiment the manifold comprises at least a quick coupling female element having a guard suitable for protecting the protrusions, and means suitable for allowing the perfect closing of the coupling to be checked from the outside.

According to a more preferred embodiment at least a of the manifold offtakes is positioned so as to indicate the perfect closing of the coupling.

According to a further feature of the present invention, the manifold can be made of metallic material and manufactured by casting and turning.

### LIST OF FIGURES

This and other features of the present invention will appear clearer from the following description of a preferred non-limiting embodiment, set forth with reference to the enclosed schematic figures, wherein:

FIG. 1 shows a perspective view of a manifold for fluids according to the invention;

FIG. 2 shows a longitudinal cross-section view of the manifold of FIG. 1;

FIGS. 3a, 3b show cross-section views according to the cross-section planes B-B and C-C of FIG. 2; and

FIG. 4 shows a longitudinal cross-section view of a couple of manifolds according to the invention, coupled together.

### DETAILED DESCRIPTION

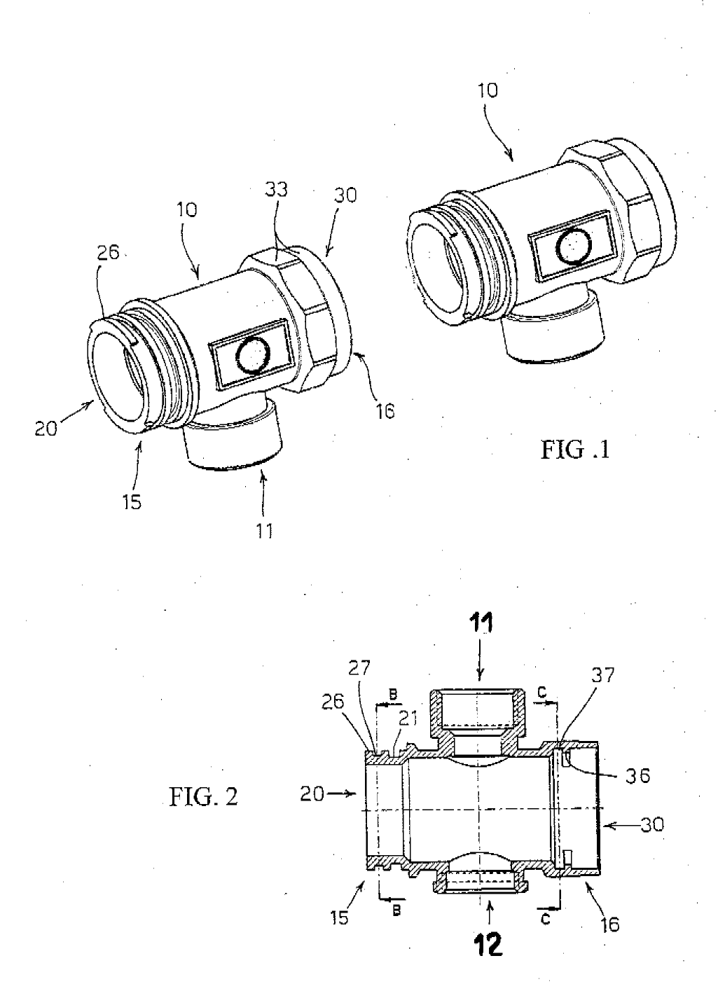

Referring to FIG. 1, a manifold for fluids (manifold) 10 according to the invention comprises as an example:
a quick coupling male element (male element or male) 15 having a predetermined length and associated, as an example, to a main inlet 20; and
a quick coupling female element (female element or female) 16 associated, as an example, to a main outlet 30 of the manifold, preferably, coaxial with the main inlet 20.

The male element 15 of a first 10 manifold or hydraulic device and the female element 16 of a second manifold or hydraulic device, when coupled, are suitable for providing a quick action coupling.

Moreover in the preferred embodiment the manifold 10 comprises a first offtake 11 for supplying fluids and, in alternative embodiments, as an example, a second offtake 12 like shown in FIGS. 2 and 4 or further offtakes.

In the preferred embodiment, the first and second offtake, 11 and 12, are provided with threads of known kind so as to allow themselves to be connected, in a known way, with corresponding threads as an example of pipes or pipe fittings. However such offtakes can also being provided with quick action coupling elements according to the present invention.

In the preferred embodiment the male element 15 comprises a seal seat 21 (FIGS. 1 to 4), as an example having rectangular shape, and arranged so as to house a toroidal gasket (gasket) 17. The gasket, as described in further detail hereinafter, is suitable for providing, in known way, a fluid-tight coupling.

In the preferred embodiment the male element 15 further comprises a pair of annular male segments (fins of the male) 26 and a ring-like male recess (male recess) 27, as an example having rectangular cross-section, suitable for cooperating in known way with a corresponding pair of annular female segments (fins of the female) 36 and a corresponding ring-like female recess (female recess) 37 so as to realize the coupling according to the invention.

The couples of fins, male 26 and female 36 respectively, as an example extend as a circle or radially and extend over a circular sector of about 90°; the couples of fins 26 and 36 respectively are suitable for being coupled together, as it will be describer hereinafter in further detail, through a rotation as an example of the male 15 relative to the female 16 by about 90°.

The recesses 27 and 37 respectively are suitable for housing, in a known way, the pairs of annular segments 36 and 26 respectively and, in the preferred embodiment, extend as an example, over the whole circumference and are not provided with any mechanical stop element.

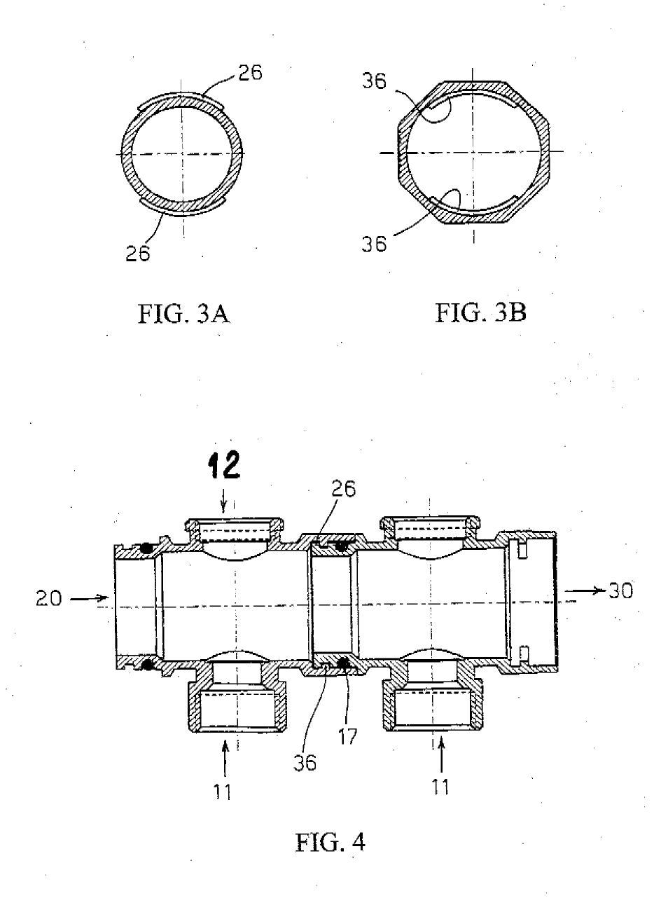

The pairs of annular segments or fins, male 26 and female 36 respectively, as an example are arranged so as to have a symmetry axis aligned with the first offtake 11. Like shown in the example of FIG. 3a, the pairs of fins can be arranged symmetrically relative to the vertical axis.

In general the pairs of annular segments or fins are made so as to be positioned in relative identical positions relative to the first 11 or to the second offtake 12 respectively, or to at least a of the offtakes.

This kind of configuration, as it will be described in detail hereinafter, is such to allow the male 15 and the female 16 to be completely coupled using the first 11 or the second offtake 12 of the manifold 10 as coupling reference, with no need of mechanical stop elements inside the manifold or of shaping the elements of the coupling as protrusions.

Of course in other embodiments the coupling reference can be associated to suitable indications provided on the manifold or on the element to be connected to the manifold, and however arranged so as to keep a predetermined relation with the pair of fins, male 26 and female 36 respectively, instead of being associated to one of the offtakes.

In the preferred embodiment the female element 16 comprises a protection shell (shell) 33 substantially shaped as an outer circular ring and suitable for protecting the male element 15 during use.

In the preferred embodiment the shell 33 has a depth equal to or greater than the length of the male 15 and inside is shaped so as to comprise, starting from the inner part, the female recess 37, the pair of female fins 36 and a substantially flat surface (inner surface of the shell) extending towards the outside of the main outlet 30.

In the preferred embodiment the shell 33 is externally shaped with a substantially hexagonal cross-section, but any other alternative shape, compatible with the function of protecting external shell, can also be used.

The process for assembling or connecting the manifold 10 with an equivalent manifold, that is herein taken as reference example, or with pipe fittings, pipings or hydraulic devices comprising quick action coupling elements as described, is the following.

After having aligned the two manifolds 10 comprising, as an example, one or two offtakes, so that the first offtake 11 of a first manifold 10 is oriented at an angle of 90° relative to the first offtake 11 of a second manifold 10, the connection procedure provides for a substantially axial force along the outlet axis 20, 30 to be applied, such force being suitable for allowing the male 15 of the first manifold 10 to be fitted in the female 16 of the second manifold.

During the fitting phase the gasket 17 is suitable for applying a substantially radial pressure relative to the longitudinal axis of the manifolds on the inner surface of the shell 33.

When the fitting phase is over, one of the two manifolds is rotated in a whichever direction, so as to align the first offtake 11 of the first manifold with the first offtake 11 of the second manifold.

After this rotation phase, the connection of the two manifolds is terminated so that the pairs of annular segments, the male 26 and the female 36 respectively, are suitable for ensuring a fluid-tight axial sealing and the gasket 17 is suitable for ensuring the radial fluid-tight sealing of the coupling so obtained.

Of course the alignment in the fitting—and coupling phase can be carried out using suitable indications provided on the manifold and on the hydraulic device to be coupled, instead of the offtakes.

For disassembling the coupling it will be sufficient, as a technician skilled in the field can easily understand, to rotate, in a whichever direction, one of the two manifolds so as to direct the first offtake 11 of the first manifold 10 at an angle of 90° relative to the first offtake 11 of the second manifold 10 and to apply an axial force so as to in such axial sense to space the manifolds.

The coupling so obtained provides the advantage that is fully protected by the guard 33 so that no body can hit the coupling elements and cause damages or the coupling itself to be accidentally disassembled. Moreover the pipes or hydraulic devices connected to the offtakes will keep the position stable.

Advantageously, the coupling does not require any mechanical stop element associated to the coupling elements, since the completion of the connection can be checked visually from the outside and therefore the coupling is not subject to assembly errors.

Advantageously, the described manifold has a very simple manufacture. In fact such manifold requires, as a technician skilled in the technical field can easily understand, simple mechanical workings, such as making recesses (grooves) on the male element and on the female element.

The manifold can therefore be made of metallic material, such as brass, aluminum and, for diameters greater as an example than 50 millimeters, also of steel, through forming or forging or casting and finish by turning thereafter.

Of course the manifold can also be made of plastic material by molding.

Summarizing, in the Applicant's opinion the previously described quick coupling manifold, even if it has a simple structure is arranged so as to allow both the coupling to be protected with a guard and the complete closing of the coupling to be recognised from the outside.

The manifold 10 has been described with male- and female quick coupling elements, but in other embodiments the manifold can comprise only one of such elements and comprise as second coupling element a threaded element to be coupled with corresponding coupling threaded elements.

The manifold has been described with coupling male elements comprising toroidal sealing gaskets but, in other embodiments, such gaskets can be replaced with toroidal lobed-gaskets or lip seals, known per se.

Obvious modifications or variants to the above description are possible, in dimensions, shapes, materials, elements, as well as in the details of the circuits, of the construction shown and of the operation method without departing from the spirit of the invention as specified in the following claims.

1-10. (canceled)

11. Manifold for fluids comprising a main inlet (20) and a main outlet (30) for a fluid, and at least an offtake (11) for supplying said fluid or checking features of said fluid, comprising at least a quick coupling female element (16) associated to at least a among said main inlet (20), said main outlet (30) and said at least an offtake (11), and suitable for being coupled during use with a corresponding quick coupling male element (15) so as to provide a quick action coupling; and wherein:
said at least a quick coupling female element (16) substantially comprises a protecting shell (33) having substantially an annular shape and arranged so as to protect during use said corresponding quick coupling male element (15);
and in that said manifold comprises
at least a coupling reference visible from the outside and suitable for allowing the carrying out of said quick action coupling to be visually checked.

12. Manifold according to claim 11, wherein
said at least a quick coupling female element (16) is associated to said main outlet (30); and in that
a quick coupling male element (15) is associated to said main inlet (20).

13. Manifold according to claim 11, wherein a threaded element of a coupling is associated to at least a among said main inlet (20), said main outlet (30) and said at least an offtake (11).

14. Manifold according to claim 11, wherein said at least an offtake (11) can be arranged like said at least a coupling reference visible from the outside.

15. Manifold according to claim 11, wherein said protecting shell (33) comprises inside said shell
a circular recess (37) of quick coupling female- (16) or -male element;
a couple of female annular segments (36); and
a substantially flat surface;
and in that said corresponding quick coupling male element (15) comprises
a couple of annular segments (26) of a quick coupling male element (15) or of a male, suitable for being housed in said circular recess (37) of female during use;
a circular recess (27) of a male suitable for housing said couple of annular segments (36) of female.

16. Manifold according to claim 15, wherein said corresponding quick coupling male element (15) comprises a further circular recess (21) of male suitable for housing a sealing gasket.

17. Manifold according to claim 15, wherein said couple of annular segments (36) of female and said couple of male annular segments (26) extend over a circular sector of about 90°.

18. Manifold according to claim 11, wherein said corresponding quick coupling male element (15) has a predetermined length, and in that said protecting shell (33) has a depth equal to or greater than the length of said quick coupling male element (15).

19. Manifold according to claim 11, characterised by being made of metallic material.

20. Manifold according to claim 19, characterised by being made by forming or forging or casting and mechanical finish thereafter.
